(19) United States
(12) Patent Application Publication
(10) Pub. No.: US 2012/0318624 A1
(43) Pub. Date: Dec. 20, 2012

(54) DETECTING THE PRESENCE OF A VEHICLE

(75) Inventors: Timothy Russell Dickson, Kingston (CA); Kurt Vollenwyder, Kingston (CA); Sidney Berry, Kingston (CA)

(73) Assignee: BOMBARDIER TRANSPORTATION GMBH, Berlin (DE)

(21) Appl. No.: 13/580,440

(22) PCT Filed: Feb. 22, 2011
(86) PCT No.: PCT/EP2011/000835

§ 371 Date: Aug. 22, 2012

(30) Foreign Application Priority Data
Feb. 23, 2010 (GB) 1003079.9

(51) Int. Cl. B60L 15/00; G01S 1/04

(52) U.S. Cl. 191/10; 342/457

(57) ABSTRACT

An arrangement for detecting the presence of a moving vehicle includes an emitting antenna adapted to emit an electromagnetic field in a range of emitting directions and mounted on the vehicle.

At least one receiving antenna for receiving the electromagnetic field is mounted on the track of the vehicle. A detector device which is connected to the at least one receiving antenna and is adapted to produce a detection signal depending on a received field intensity of the electromagnetic field that is received by the at least one receiving antenna.

The invention relates to an arrangement and a method for detecting the presence of a moving vehicle, in particular a track bound vehicle. In particular, the track bound vehicle may be a light rail vehicle (e.g. a tram).

In particular track bound vehicles, such as conventional rail vehicles, mono-rail vehicles, trolley busses and vehicles which are guided on a track by other means, such as other mechanical means, magnetic means, electronic means and/or optical means, require electric energy for propulsion on the track and for operating auxiliary systems. Track bound vehicles, in particular vehicles for public passenger transport, usually comprise a current collector for mechanically and electrically contacting a line conductor along the track, such as an electric rail or an overhead line. Systems of the vehicles are operated with the electrical energy provided by the external rail or line.

Trams and other local or regional trains are operated usually via overhead lines within cities. However, especially in historic parts of cities, overhead lines are undesirable. On the other hand, conductor rails in the ground or near the ground cause safety problems.

Inductively transferring energy from the track to the vehicle, i.e. producing electromagnetic fields, is subject to restrictions regarding EMC (electromagnetic compatibility). On one hand, electromagnetic fields may interfere with other technical devices. On the other hand, people and animals should not be subjected to electromagnetic fields permanently. At least, the respective limit values for field intensity must be observed.

An electric conductor arrangement which extends continuously along the path of travel of the vehicles may be used to produce the electromagnetic fields for providing energy to the vehicles. However, this causes fields where no vehicle is present. Consequently, the arrangement may be divided in segments which can be operated separately of each other. In particular, the present invention refers to such an arrangement which is divided in separately operable segments. A preferred way of shielding the surrounding of the vehicle from the electromagnetic field generated by the segments of the arrangement is to operate a segment only if the segment is fully covered by a vehicle.

The vehicle comprises a receiver for receiving the electromagnetic field and for producing an electric voltage caused by induction. The receiver, e.g. a pick-up coil or coil arrangement, is preferably located under the vehicle's car body, close to the segment underneath the vehicle. In order to ensure that the segment is only operated while fully covered by the vehicle, the location of the vehicle on the track must be known very precisely. In particular, the position of the receiver or receivers of the vehicle should be known very precisely. Depending on the information about the position of the vehicle or the receiver(s), the segments can be energised and de-energised.

The vehicles on the track may drive at different speeds. For example, the maximum speed of a tram may be in the range of 10 to 30 m/s. This means that a delay in the detection of the position will cause an uncertainty which may result in energising or de-energising a segment too early or too late.

Any device or element which is mounted on the vehicle for detection of the position may be subject to external influences, such as wind, dirt, temperature changes, water, ice, snow and collision with impacting objects. Furthermore, the vehicle position detection system should reliably operate in a surrounding with substantial levels of electromagnetic radiation. In particular, such electromagnetic radiation should not result in false position detection. In addition, the position detection system should be sensitive only to vehicles which are to be provided with energy from the segments.

Laser beams may be used for accurate position detection, since laser beams do not diverge significantly. However, laser devices and optical means for detecting laser beams can easily be influenced by debris, ice, snow and other influences from the surrounding.

Existing proximity sensors, including sensors based on capacitive, inductive, Hall effect and ultrasonic technologies can be fast and accurate, but are not discriminating between different vehicles or vehicle types. Any signal source other than a signal source mounted to a vehicle which should be provided with energy from the segments, might trigger position detection. Similarly, weight and metal detectors would not be sensitive only to the vehicles which are to be provided with energy from the segments. Typical RFID (radio frequency identification devices) are not precise enough regarding local resolution, especially at low vehicle speeds. Any RFID-tag located in a comparatively wide local range would be detected. Furthermore, the response of the position detection system to the presence of an RFID-tag would be too slow.

Satellite-based position detection systems like the GPS (global positioning system) can be quite accurate, but the response times are too long and situations might occur in which the position detection is disturbed.

It is an object of the present invention to provide an arrangement and a method of the type described above which allow for robust, fast, and precise vehicle position detection of a moving vehicle. Preferably, a vehicle position detection signal should only be generated if a vehicle to be provided with energy from a track-side contact-less power system is located in the expected position or range of positions. In particular, “position” means a position along the track of the vehicle or vehicles.

It is a basic idea of the present invention to use a source of electromagnetic radiation which is adapted to emit the radiation in different directions, but the radiation intensity comprises a maximum or minimum. In particular, the maximum or minimum intensity may be a global or local extreme of the field intensity of the electromagnetic field emitted by the source.

In case of a maximum, it is preferred that the maximum is a global maximum, which means that the source does not emit radiation with the same or higher intensity in any other direction. Preferably the maximum is located within a narrow range of directions having intensities larger than zero. In this case, the narrow range is delimited by directions having zero intensity.

In case of a minimum, the minimum is preferably a local minimum, which means that there may be other directions in which the intensity is even smaller than for the minimum. Preferably the minimum is located within a narrow range of directions having intensities smaller than directions having a maximum intensity that delimit the narrow range.

The width of the narrow range is preferably smaller than 20 degrees, if measured in a sectional plane comprising the source and a receiver for receiving the electromagnetic field. Preferably, the angle is smaller than 17 degrees. If the source is mounted on the underside of the vehicle car body and the narrow range strikes the ground, a receiver which is located in or on the ground can detect the vehicle's position at high positional resolution. The sectional plane mentioned above is, in this case, a vertical plane comprising the source and the receiver, wherein the plane extends in the direction of travel.

Preferably, the frequency of the electromagnetic field which is emitted by the source is in the range of radio frequency radiation (about 3 kHz to 300 GHz). The corresponding range of wave lengths of the electromagnetic field is from about 100 km to 1 mm.

Especially in the case of radio frequency electromagnetic fields the source can be an antenna, i.e. an electrically conducting structure which emits the electromagnetic field while an alternating voltage is applied to the structure. The receiver or receivers may also be antennas. The term “antenna” is not restricted to a single conducting element, such as a dipole. For example, the term also includes a set of dipoles or other electrically conducting elements.

Preferably, the source is mounted to the vehicle, while the receiver or receivers are fixed with respect to the track of the vehicle. This solution facilitates detection of the presence of a vehicle in an expected position. In particular, the position detection requires evaluation of the signal which is produced by the receiver or receivers and the transfer of the evaluation result or of the signal which is produced by the receiver to a vehicle location detection device.

In addition, further steps may be performed utilising the position detection result, such as energising or de-energising a segment of a conductor arrangement which produces an electromagnetic field for providing energy to the vehicle. All these steps can be performed faster and more reliably if the receiver is fixed relative to the track. However, it is also possible that the source is fixed relative to the track and that the vehicle comprises at least one receiver for receiving the narrow maximum or minimum, so that the detection of the received maximum or minimum is performed by a device on the vehicle and that the corresponding detection result is transferred to devices which are fixed relative to the track. This transfer may be performed by wireless communication. For example, the detection result may be transferred from the vehicle to the track in form of a signal which triggers energising or de-energising a segment.

Using an electromagnetic field having a maximum or minimum intensity in a corresponding direction has the following advantages:

Producing and detecting electromagnetic fields, in particular in the radio frequency range, can be performed using robust devices which are not affected by weather, dirt and impacting objects. For example, an antenna can be protected by a cover made of material that does not significantly absorb electromagnetic fields. The material properties of the cover can be designed to resist the expected influences.

The evaluation of the signal which is produced by the receiver antenna is fast and reliable. The evaluation and transfer of electric currents and the evaluation of electric voltages produced by the receiver antenna can be performed using standard technologies which are easy to apply. For example, the output voltage of the receiver antenna is monitored as a function of time and it is determined that the vehicle has reached the expected position if the voltage corresponds to the maximum or minimum intensity. Corresponding voltage values or the voltage as a function of time can be predetermined or trained so that the maximum or minimum intensity received by the receiver can be detected reliably.

For example, assuming a typical vehicle speed of a tram and assuming that the tram should fully cover the segment while energised, the position error of the position determination should be less than 100 mm. Furthermore, the evaluation of the signal produced by the receiver of the position determination system and the communication of the evaluation result to the device controlling the energisation and de-energisation of the segment should be performed within 50 ms. These requirements can be met using the minimum or maximum detection of a radio frequency field.

Furthermore, using antennas and detectors which are sensitive to a specific range of frequencies, electromagnetic radiation at other frequencies does not influence the position detection system. In addition, as will be described later in detail, radio frequency radiation can be used to transfer coded signals, so that a coded signal which is emitted by the source is recognized as vehicle position detection signal, but any other electromagnetic wave would not trigger the vehicle position detection.

Radio frequency waves with frequencies above 10 MHz are particularly suited for the purpose of precise position detection, since the wave length is short. Furthermore, radio frequency waves are capable of carrying data by modulation of the carrier wave at high transmission rates. In other words: The bandwidth for data transmission is wide. This allows for transmission of encrypted or coded information, while the fast detection of the field intensity at the receiver and the fast recognition of the encrypted or coded information is not negatively affected.

For example, the emitting antenna may be connected to a control device for controlling the operation of the emitting antenna, wherein the electromagnetic field emitted by the emitting antenna is modulated to carry predetermined information (the encrypted or coded information) and wherein the detector device detects the presence of a vehicle only if the predetermined information is received by the at least one receiving antenna at the same time as the maximum or minimum intensity. The predetermined information may be digital or other type of information.

One example of an emitting antenna is a horn antenna, which, for example, emits radio frequency waves in the range of 20 to 30 GHz. An example will be described later. Such a horn antenna can transmit data at a data rate in the range of 1 MHz.

Other examples of an emitting antenna suitable for the present invention are dipole or loop antennas. These types of antennas typically emit electromagnetic radiation with lobe-shaped emitting characteristic (the intensity as function of the emitting direction in three dimensions), wherein the symmetry axes of two lobes are aligned to each other and are pointing to opposite directions. Consequently, a minimum intensity of the emitted electromagnetic field can be observed in directions perpendicular to the symmetry axes. Preferably, one of these minimum directions is oriented towards the receiver if the vehicle passes the location to be detected. A dipole antenna is an antenna which comprises an electrically conducting structure which has two opposite poles while operated. A loop antenna is an antenna which comprises at least one conductor loop, i.e. a conductor of the antenna extends around an area which forms the inner area of the loop. An example of an arrangement comprising such an emitting antenna and further comprising a receiver will be described later.

In particular, the arrangement of the present invention for detecting the presence of a moving vehicle may comprise:
an emitting antenna adapted to emit an electromagnetic field in a range of emitting directions, wherein the emitting antenna is to be mounted on the vehicle,
at least one receiving antenna for receiving the electromagnetic field, wherein the receiving antenna is to be mounted on the track of the vehicle,
a detector device which is connected to the receiving antenna and which is adapted to produce a detection signal depending on a received field intensity of the electromagnetic field that is received by the receiving antenna,
wherein an emitted field intensity of the electromagnetic field that is emitted by the emitting antenna is a function of the emitting direction, wherein the function comprises a maximum intensity or a minimum intensity in a predefined emitting direction and wherein the detector device is adapted to detect the presence of the vehicle if the receiving antenna receives the maximum or minimum intensity of the electromagnetic field emitted by the emitting antenna.

Consequently, the presence of the vehicle is detected if the predefined emitting direction of the emitting antenna strikes the radiation sensitive receiving area of the receiver.

The term “function of the emitting direction” means that the emitted field intensity may vary depending on the emitting direction of the emitted electromagnetic field.

The detector device may be connected to the receiving antenna via an electric connection. For example, the detector device may detect continuously or repeatedly the voltage which is produced by the receiving antenna due to incident electromagnetic radiation. Furthermore, optionally, the detector device may comprise a unit which is adapted to extract the data which was transferred from the emitting antenna to the receiving antenna using the electromagnetic field, if such data was transferred at all. For example, the detector device may comprise a unit for decoding a coded signal which was received by the receiving antenna. A comparison unit may compare the decoded signal or may directly compare the coded signal with an expected signal or code and may decide that the signal was emitted by an expected vehicle or an expected type of vehicle if the decoded signal or coded signal corresponds to the expected signal or code. Thus, such a detector device is capable of recognising that the electromagnetic field was emitted by an emitting antenna of a predefined type of vehicles or of a specific vehicle and, for example, the detector device outputs an enable signal only if it determines that the received electromagnetic field was emitted by the predefined type of vehicles or by the specific vehicle. The enable signal may be received by another device which energises or de-energises a segment of the type described above on receipt of the enable signal. Such another device may be the control of an inverter or switch which connects a power supply line to the segment which generates an electromagnetic field while energised.

According to a specific embodiment, at least three receiving antennas are arranged on the track of the vehicle, one behind another in the direction of travel of the vehicle, wherein the detector device is connected to each of the receiving antennas, wherein the detector device is adapted to evaluate the received field intensity received by each of the receiving antennas and wherein the detector device is adapted to determine information about the received field intensity depending on the position along the track from the field intensity received by the at least three receiving antennas.

The evaluation of the received field intensity received by each of a plurality of receiving antennas increases the reliability and/or precision of the vehicle location detection. In particular, a maximum intensity is reliably detected if the intensity received by the receiving antenna in the middle position between the other two receiving antennas is larger than for the received intensity of the neighbouring two antennas.

However, the arrangement comprising at least three receiving antennas is particularly useful if a minimum intensity is to be detected. In this case, the detector device decides a vehicle is passing an expecting location on the track, if a first one of the at least three receiving antennas and a third one of the at least three receiving antennas receive a larger field intensity than a second one of the at least three receiving antennas in between the first and third receiving antenna.

Furthermore, a method of detecting the presence of a vehicle is proposed, wherein:
an emitting antenna, which is mounted on the vehicle, is controlled to emit an electromagnetic field in a range of emitting directions, wherein a field intensity of the emitted electromagnetic field is a function of the emitting direction and wherein the function comprises a maximum intensity or a minimum intensity in a predefined emitting direction,
at least one receiving antenna, which is mounted on the track of the vehicle, is used to receive a received electromagnetic field, while the vehicle is travelling in a predetermined region of the track, so that part of the emitted electromagnetic field is incident on the receiving antenna,
a detector device, which is connected to the receiving antenna, is used to detect the presence of the vehicle depending on the field intensity that is received by the receiving antenna,
   wherein the detector device detects the presence of the vehicle if the receiving antenna receives the maximum or minimum intensity of the emitted electromagnetic field.

Features of embodiments of the method correspond to embodiments of the arrangement described in this specification. Some embodiments of the method are defined in the patent claims.

Generally speaking, location detection is equivalent to the detection of the presence of a moving vehicle at an expected position. The expected position corresponds to the situation described above, wherein the predefined emitting direction is oriented towards the radiation sensitive receiving area of the receiving antenna.

As mentioned above, the emitting electromagnetic field is emitted in a range of emitting directions, wherein a field intensity of the electromagnetic field is a function of the emitting direction and wherein the function comprises a maximum intensity or a minimum intensity in a predefined emitting direction. This emitting direction is preferably referred to the vehicle, not to the track. The emitting antenna is positioned and oriented in such a manner that the maximum intensity or minimum intensity is incident on the receiving antenna if the emitting antenna of the vehicle (and thereby a distinguished part of the vehicle) is in a predetermined expected location. In particular, the vehicle may pass the location of the receiving antenna in such a manner that the predetermined direction is aligned with a centre line or with another distinguished direction of the receiving antenna. This centre line or other distinguished direction may be the direction of highest sensitivity of the receiving antenna, for example.

In any case, the combination of the detector device and of the at least one receiving antenna is adapted to detect if the maximum intensity or minimum intensity received by the receiving antenna. This situation is the expected situation or expected state to be detected, i.e. the detector device may output a signal indicating the presence of the vehicle. In all other situations or states, the detector device will not detect the presence.

The at least one receiving antenna is to be mounted on the track of the vehicle. The term “track” comprises all parts and materials which stay at rest while the vehicle is travelling. For example, the receiving antenna may be mounted to the rail construction (e.g. sleepers of the rails) of a railway or may be buried in the ground (e.g. embedded in concrete material of the track). Therefore a synonym for “mounted on the track” is “fixed relative to the track of the vehicle”.

In particular, the invention relates to systems which transfer energy from an electric conductor arrangement, which is arranged along the track, to the vehicles travelling on the track without having electric contact between the vehicle and the conductor arrangement. The conductor arrangement carries an alternating current which generates a respective electromagnetic field and the electromagnetic field is used to transfer the electric energy to the vehicle.

For example, the conductor arrangement is located in and/or under the track, e.g. under the surface of the ground on which the vehicles travel. However, the invention also includes the case that at least a part of the conductor arrangement is located sideways of the track, for example when the track is located in the country side or in a tunnel. The frequency of the alternating current which flows through the conductor arrangement may be in the range of 5-100 kHz, in particular in the range of 10-30 kHz, preferably about 20 kHz, for example.

The conductor arrangement comprises a plurality of consecutive segments, wherein each segment extends along a different section of a path of travel of the vehicles. Each of the consecutive segments comprises at least one phase line for carrying a phase of an alternating current for producing the alternating electromagnetic field. Corresponding phase lines of neighbouring consecutive segments for carrying the same phase of the alternating current are connected in series to each other. Such a series connection reduces the number of electric or electronic components needed to operate the segments. In particular, the number of inverters and cables can be reduced.

For example, there are three phases of the alternating current and, correspondingly, three phase lines in each segment. The phase shift of the currents which flow through the different phase lines may be, as usual, 120 degrees. However, the invention also covers arrangement having only one or two phases or more than three phases.

Furthermore, the arrangement comprises a power supply line for supplying electric energy to the segments. The power supply line may be a direct current (DC) or alternating current (AC) power supply line. In case of an AC power supply line the alternating current is to be converted to the desired alternating current of the conductor arrangement. In case of a DC power supply line the direct current is to be inverted, i.e. an inverter is required for inverting the direct current carried by the power supply line to the alternating current of the conductor arrangement. The converter or inverter is connected to each interface between two neighbouring consecutive segments, thereby connecting the power supply line with the phase lines of the neighbouring consecutive segments. In the following, the term “switching device” is used as a general expression for the converter, inverter or other arrangement of switches.

In addition, the switching devices connecting the power supply line and the phase lines can be operated in such a manner that desired sectors (comprising one or more than one of the consecutive segments) of the conductor arrangement are active (produce the electromagnetic field) and other sectors are not active (do not produce an electromagnetic field). If segments are active only while a vehicle is traveling within the respective region of the path of travel, energy is saved and EMC requirements can easily be fulfilled. In other words: the concept of the preferred embodiment of the present invention is to produce the alternating current locally and preferably where and when necessary.

For example, the lengths of the segments along the path of travel are shorter than the length of a vehicle in the travel direction and the segments may be operated only if a vehicle is already occupying the respective region of the path of travel along which the segment extends. In case of a rail vehicle, “occupied” means that the vehicle is driving on the rails along which the segment extends. Preferably, the segments are operated only if the vehicle is fully occupying the respective region of the path of travel. For example, the rail vehicle is longer (in the direction of travel) than the segment and the vehicle's front and end are driving beyond the limits of the segment, if viewed from the center of the segment. Therefore a segment may also be switched on (i.e. the alternating current through the segment is starting to flow) before a receiving device of a vehicle for receiving the transferred energy enters the region of the path of travel along which the segment extends.

In case of a DC power supply line, an inverter is used as switching device. Typically, the inverters comprise two electrically controllable semiconductor switches (e.g. Insulated Gate Bipolar Transistors) in series to each other for each phase of the alternating current in the conductor arrangement. The inverter produces the alternating current by repeatedly switching on and off the switches. This technology of manufacturing and operating inverters is well known in practice.

Examples and further embodiments of the invention will be described with reference to the attached drawings. The figures show:

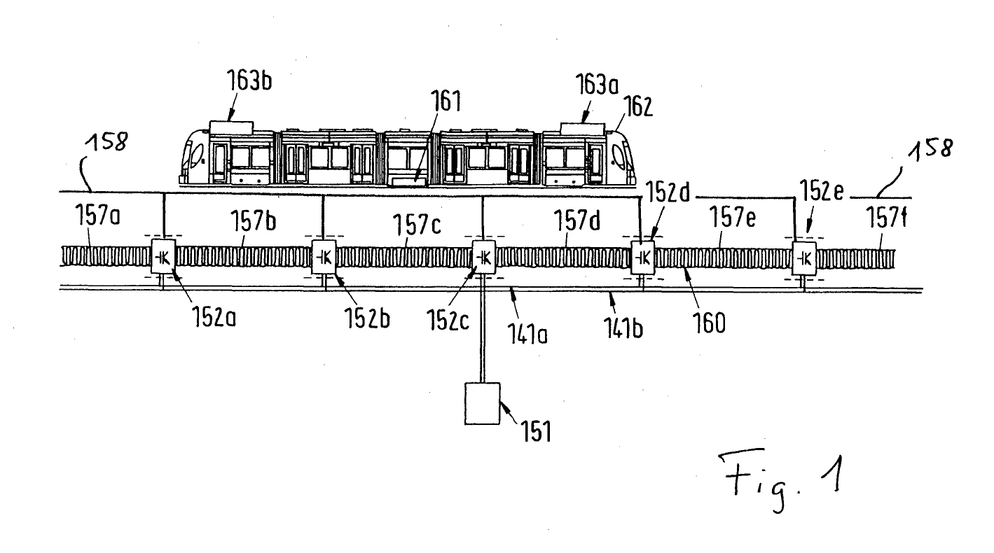

FIG. 1 schematically a rail vehicle which is travelling on a track, wherein the track is provided with a conductor arrangement for transferring electromagnetic field energy to the vehicle,

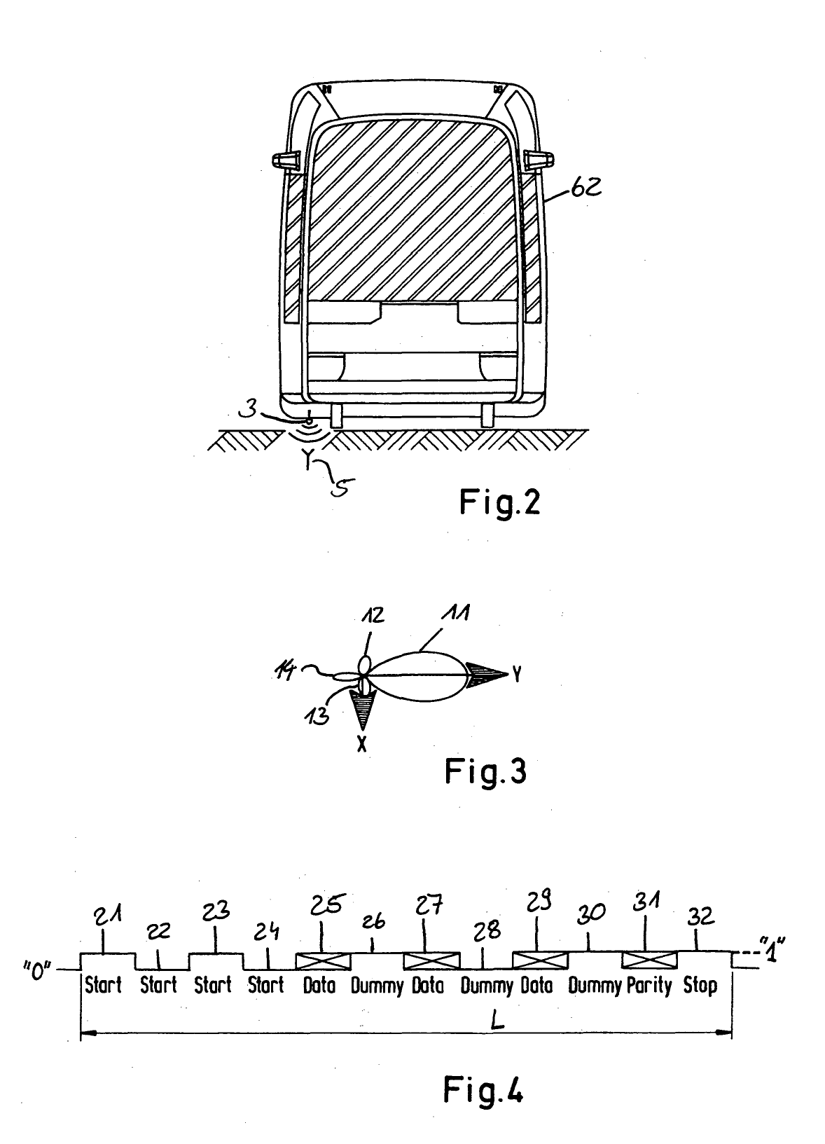

FIG. 2 a sectional view of a rail vehicle and part of the track of the rail vehicle, wherein the plane of the sectional view is a vertical plane, wherein the direction of travel is perpendicular to the plane,

FIG. 3 the emitting characteristic of a horn antenna,

FIG. 4 an example of a data frame of coded data to be transferred together with the emitted electromagnetic field to the receiving antenna,

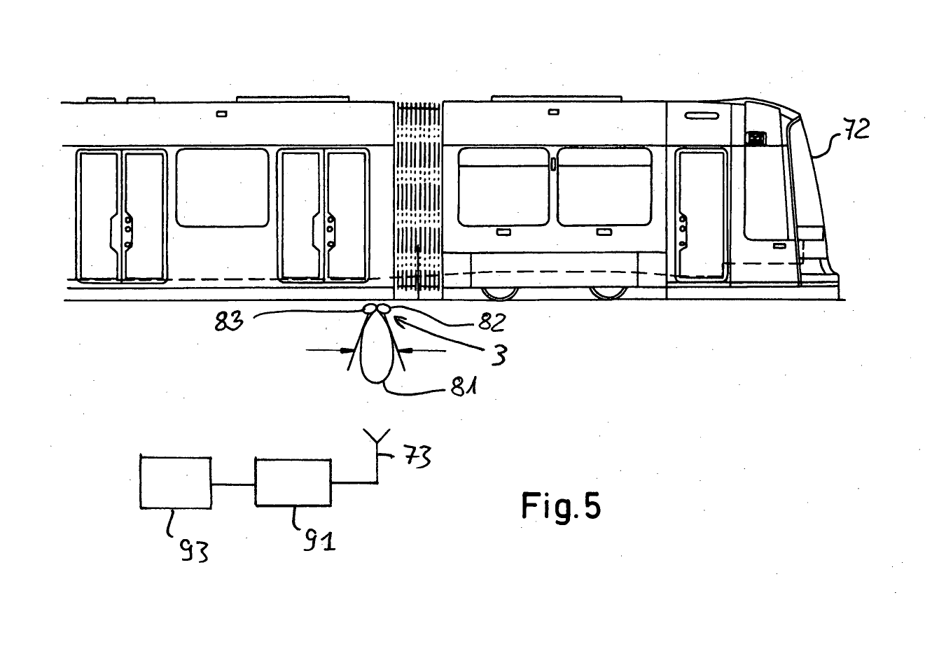

FIG. 5 a side view of a part of a rail vehicle having a downwardly facing emitting antenna, wherein a receiving antenna which is fixedly mounted relative to the track is shown schematically,

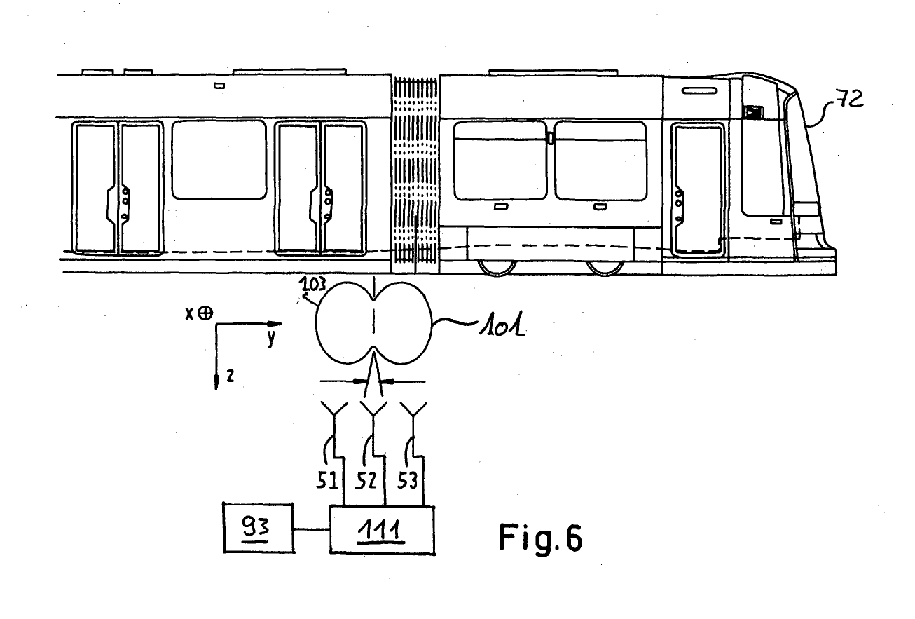

FIG. 6 a side view similar to the side view shown in FIG. 5, wherein an arrangement of three receiving antennas which are arranged one behind another in the direction of travel are fixedly mounted to the track of the vehicle.

FIG. 1 shows a rail vehicle 162, for example a tram. The vehicle 162 comprises two energy storages 163a, 163b located at the roof of the vehicle. The energy storages 163 may be, for example, conventional batteries and/or capacitors. A pick-up 161 for receiving an electromagnetic field and for converting the field by induction to electric energy is located at the bottom of the vehicle 162. The travel direction within the schematic drawing of FIG. 1 is from left to right or from right to left.

As shown below of the vehicle 162, a conductor arrangement extends along the track of the vehicle 162. The conductor arrangement comprises a series of consecutive segments 157. FIG. 1 shows six consecutive segments 157a-157f. At each interface between two neighbouring consecutive segments (for example, segments 157b, 157c or segments 157d, 157e are neighbouring consecutive segments) an inverter 152 is connected to the phase lines of each of the two neighbouring consecutive segments. FIG. 1 shows five inverters 152a-152e. The phase lines are located on the alternating current side of the respective inverters 152. On the direct current side, each inverter 152 is connected to a DC power supply comprising two power supply lines 141a, 141b at different electric potential. The DC power supply lines are fed by a central DC power source 151. Although the specific embodiment described here comprises a DC power supply, an AC power supply may be used instead. In this case, the inverters are replaced by corresponding converters or by an arrangement of switches.

Furthermore, a control signal line 158 also extends along the track of the vehicle 162. Each inverter 152 comprises a control signal node which is connected to the control signal line 158. For example, the control signal line 158 may be a data bus and each inverter 152 may comprise a corresponding bus controller for receiving and optionally sending messages via the data bus to other devices. An individual address may be assigned to each inverter 152 so that data packages comprising the address can be recognized by the bus controller and the content of the package can be used to control the operation of the respective inverter in a coordinated fashion with the operation of the other inverters 152.

As an example, a receiving antenna (which may be located at the location of the inverter 152d, i.e. at the interface between segments 157d, 157e) may detect that the emitting antenna of the vehicle 162 has reached a position vertically above an expected position (e.g. the position at the interface between segments 157d, 157e). As a result, inverters 152d and 152c are operated in such a manner that segment 157d is energised and therefore produces an electromagnetic field.

However, the conductor arrangement shown in FIG. 1 is just an example. Alternatively, the consecutive segments may not directly be connected to each other. In this case, each segment may be connected to the power supply line via a single inverter. According to a further alternative, the power supply line may not be a direct current line, but may be an alternating current line.

The rail vehicle 62 which is shown in FIG. 2 comprises a transmitting antenna 3 mounted to the underside of the rail vehicle 62. The electromagnetic field which is emitted by the emitting antenna 3 is oriented downwardly in vertical direction. This means that the vertical emitting direction comprises a maximum intensity or a minimum intensity of the emitted electromagnetic field.

If the travelling vehicle 62 reaches a position along the track where the vertical direction coincides with the vertical direction of a receiving antenna 5 which is fixedly mounted relative to the track, the maximum or minimum intensity can be detected by evaluating the signal which is produced by the receiving antenna 5.

However, it is not obligatorily to orient the maximum direction or the minimum direction in vertical direction. For example, the maximum or minimum direction can be inclined by an angle in the range between 0 and 20 degrees relative to the vertical direction. In this case, the receiving antenna is preferably also inclined with respect to the direction of highest sensitivity. Generally speaking, the emitting antenna and the receiving antenna are oriented in such a manner that the receiving antenna receives the maximum or minimum intensity if the vehicle is in a corresponding predetermined position. Consequently, the detection of the minimum or maximum intensity can energising or de-energising a segment which is capable of producing an electromagnetic field to be received by a pick-up of the vehicle.

Preferably, the predetermined position is chosen in such a manner that the segment is energised only while the segment is fully covered by a vehicle. In order to achieve this, the track comprises at least two receiving antennas with different predetermined positions. A first predetermined position is chosen so that the segment is energised when the vehicle reaches the predetermined position and a second predetermined position is chosen so that the segment is de-energised when the vehicle reaches the second predetermined position.

If the segments are short enough (in the direction of travel) that the vehicle always covers at least three consecutive segments, the detection of a maximum or minimum intensity which is received by a receiving antenna can trigger energising one segment and can trigger at the same time de-energising of another segment. For example, if the vehicle 162 shown in FIG. 1 travels to the right, segment 157d can be switched on (or energised) as soon as the front of the vehicle 162 reaches inverter 152d. At the same time segment 157b can be switched off using the same trigger signal which triggers the energising of segment 157d.

FIG. 3 shows an emitting characteristic of an emitting antenna. This emitting characteristic is designed to produce a maximum intensity in Y-direction. The diagram of FIG. 3 shows four lobes 11, 12, 13, 14. The emitting characteristic comprises two more lobes oriented in Z-direction, which are not shown in FIG. 3, since the Z-direction is perpendicular to the image plane of FIG. 3.

To be precise, FIG. 3 shows cross sections of the four lobes 11, 12, 13, 14. Each lobe is rotationally symmetric to a direction of symmetry. In case of the lobe 11, this direction of symmetry is the Y-direction. One of the other lobes, namely lobe 14, is also rotationally symmetric to the Y-direction, but is pointing in the opposite direction of the direction of lobe 11. The point of origin of the radiation is the cut-point of the X-axis and of the Y-axis as well as of the Z-axis which is not shown in FIG. 3. The intensity in a specific direction is proportional to the length of the connecting line from the cut-point to the point intersecting the contour of the lobe. Therefore, the connecting line from the cut-point to the right, in Y-direction, corresponds to the maximum intensity of the electromagnetic field which has the emitting characteristic shown in FIG. 3.

FIG. 4 shows a data frame having 12 bits 21-32. Each bit may have the value “0” or “1” as indicated in FIG. 4. However, the values of some of the bits 21-32 may be predetermined and fixed so that the data frame can be recognised.

Starting from left to right, the first bit 21 having the value “1” is one of the four start bits 21, 22, 23, 24 of the data frame. The values of the four start bits 21-24 are fixed. The value of the second start bit 22 is “0”. The value of the third start bit 23 is “1” and the value of the fourth start bit 24 is “0”. The fifth bit 25 is the first data bit. Depending on the data to be transferred, this bit 25 may have the value “0” or “1”. The sixth bit 26 has a fixed value “1”. It serves to separate the first data bit 25 from the second data bit 27, which is the seventh bit. This second data bit 26 may have the value “0” or “1” depending on the message to be transferred. The second data bit 26 is followed by another bit 28 which separates the second data bit 27 from the third data bit 29. Again, the third data bit 29 may have the value “0” or “1”. This third data bit 29 is followed by another bit 30 which has a fixed value of “1”. The next following bit 31 is a parity bit, which means that it may have the value “0” or “1” depending on the parity of the three bit information corresponding to the values of the data bits 25, 27, 29. Thus, inconsistencies in the three-bit message can be detected using the parity bit. The last bit 32 is the stop bit having the fixed value of “1”.

Such a three-bit message using a twelve-bit data frame can easily be modulated on a radio frequency carrier wave which is emitted by an emitting antenna. Preferably, the data frame of another coded signal is permanently emitted by the emitting antenna, which means that the coded signal is repeated continuously. In case of the data frame shown in FIG. 4, the same data frame is emitted again, as soon as the emission of the data frame is finished. However, the modulation method is not necessarily a modulation in which a specific time interval of the emitted electromagnetic field corresponds to a single data frame. However, the detection device which is connected to the receiving antenna can decode or decrypt the received signal so that the emitted data frame or other coded signals can be restored.

The modulation of a carrier wave is well-known in the art of data transfer systems and is therefore not described in detail here.

The twelve-bit data frame shown in FIG. 4 may be transmitted at a frequency of 1 MHz using a carrier wave having a frequency of 24 GHz. Consequently, such a twelve-bit frame can be received in only 36 μs. Therefore, it is possible to detect a maximum or minimum intensity received by a receiving antenna and to decide within 36 μs plus the respective data processing time that the maximum or minimum intensity is emitted by an expected vehicle or type of vehicle or not. Only if the received maximum or minimum intensity is emitted by such an expected vehicle or type of vehicle, the recognition signal is produced which triggers the energisation or de-energisation of a segment.

FIG. 5 shows the front part of a vehicle 72. The emitting characteristic of an emitting antenna which is fixed to the underside of the vehicle 72 is shown. Similarly to the emission characteristic shown in FIG. 3, the emission characteristic shown in FIG. 5 comprises a plurality of lobes 81, 82, 83. Lobe 81 has a symmetry direction which is oriented in vertical direction, pointing downwards. A receiving antenna 73 which is schematically shown by a Y-shaped symbol and which is fixed relative to the track of the vehicle 72, is sensitive to received electromagnetic fields which are oriented in directions extending from top to bottom, but are not necessarily vertical.

In the situation shown in FIG. 5, the maximum intensity of the electromagnetic field which corresponds to the maximum intensity of lobe 81, is incident the receiving antenna 73. A detection device 91 which is connected to the receiving antenna 73 therefore receives a maximum voltage corresponding to the maximum intensity received, detects the maximum voltage, for example by comparing with a predetermined threshold value which is exceeded by the maximum voltage, and outputs a recognition signal to a control device 93 which is connected to the detection device 91. The control device 93 may be the control device of an inverter or other switching device, for example it may be the control device of one of the inverters 152 shown in FIG. 1. Consequently, the recognition signal may trigger the energisation or de-energisation of a segment for transferring energy to the vehicle 72. The lobe 81 shown in FIG. 5 is emitted within a small range of directions as indicated by two diverging straight lines and two arrows for a horn antenna for example, the narrow range of lobe 81 may have an angle of less than 20 degrees, for example of 70 degrees (the angle between the two diverging straight lines).

FIG. 6 shows a similar view as FIG. 5. However, the emission characteristic of the emitting antenna at the underside of the vehicle 72 is different compared to FIG. 5. The emission characteristic comprises two lobes 101, 103 which have symmetry axes oriented in the horizontal direction. As shown by two diverging straight lines at the bottom of the emission characteristic, a minimum intensity is emitted downwards within a very small range of emission directions extending from top to bottom. A threshold value of the intensity received by a receiving antenna arrangement 51, 52, 53 can be defined so that the intensity in the narrow range of directions is smaller than the threshold value. In practise, a voltage threshold value may be predetermined instead of an intensity threshold value. If the voltage which is produced by the middle one 52 of the three receiving antennas due to the incident electromagnetic field, is below the predetermined voltage threshold value, and if the voltages which are produced by the two neighbouring receiving antennas 51 and 53 are higher than the same predetermined threshold value or are higher than a second, higher predetermined threshold value, the reception of the minimum intensity is detected and a corresponding recognition signal may be produced.

The receiving antennas 51, 52, 53 are connected to a detection device 111 which performs the detection of the minimum intensity. The detection device 111 is connected to a recognition device and outputs a minimum detection signal to the recognition device if the minimum is detected. Alternatively, the detection device 111 may detect just the signal intensities and may, for example, output corresponding voltages to the recognition device 93. Instead of a single detection device 111, each receiving antenna 51, 52, 53 can be connected to an individual detection device.

Such an arrangement as shown in FIG. 6 allows for increased positional resolution in the position detection compared to the arrangement shown in FIG. 5. For example, a dipole or lobe antenna can be used as emitting antenna. This antenna may be, for example, operated at a carrier wave frequency of 40.68 MHz, which is a frequency for unlicensed industrial, scientific or medical data transmission applications. For example, the three-bit message shown in FIG. 4 may be transferred using this carrier frequency at a data rate of 1 MHz. If the very narrow range of emitting directions shown in FIG. 6 is in the range of 1 to 3, preferably 2 degrees, a positional resolution of the position detection of 7 MHz can be achieved. For example, the time for receiving the twelve-bit data frame may be the same as mentioned above, namely 36 μs.

The three or more receiving antennas for detecting the reception of the minimum intensity may be realised as antenna structures carried on a single carrier material, for example a circuit board for carrying electric or electronic circuits. The plurality of receiving antennas is arranged one behind another in the direction of travel. This arrangement of receiving antennas can be described as a sequence or chain of antennas, wherein the first and last element of the sequence or chain has only one neighbour antenna, whereas all middle antennas have two neighbours. Therefore, each middle antenna can be used to detect the minimum intensity and the neighbours or further receiving antennas of the sequence or chain can be used to confirm that the signal intensity received by the middle antenna is significantly smaller than the signal intensity received by the neighbouring or further antennas. The threshold criterion described above using one threshold or two thresholds can be applied to more than three receiving antennas in the sequence or chain. However, alternative procedures for confirmation of the significantly higher intensity received by the neighbour antennas can be applied. For example, the difference between field intensity received by the middle antenna and the field intensities received by the neighbouring antennas can be determined and can be compared with a threshold value for the difference. If the difference is greater than the difference threshold value, the detection of the minimum intensity is confirmed.

All antennas, the emitting antenna and the receiving antenna(s) can be protected against obstruction, since electromagnetic waves easily penetrate non-absorbing materials which may be used as cover materials for the antennas.

1. An arrangement for detecting the presence of a moving vehicle, the arrangement comprising:
an emitting antenna adapted to emit an electromagnetic field in a range of emitting directions, wherein the emitting antenna is to be mounted on the vehicle,
at least three receiving antennae for receiving the electromagnetic field, wherein the receiving antennae are to be mounted on the track of the vehicle, wherein the at least three receiving antennae are arranged on the track of the vehicle, one behind another in the direction of travel of the vehicle,
a detector device which is connected to each of the receiving antennae, which is adapted to evaluate the received field intensity received by each of the receiving antennae, which is adapted to determine information about the received field intensity depending on the position along the track from the field intensity received by the at least three receiving antennae and which is adapted to produce a detection signal depending on a received field intensity of the electromagnetic field that is received by the receiving antenna,
wherein an emitted field intensity of the electromagnetic field that is emitted by the emitting antenna is a function of the emitting direction, wherein the function comprises a maximum intensity or a minimum intensity in a predefined emitting direction and wherein the detector device is adapted to detect the presence of the vehicle if one of the receiving antennae receives the maximum or minimum intensity of the electromagnetic field emitted by the emitting antenna and the maximum intensity
a) is detected by the detector device and the detector device decides that a vehicle is passing an expected location on the track if the intensity received by the receiving antenna in a middle position between the other two receiving antennae is larger than for the received intensity of the neighboring two antennae, or
b) the minimum intensity is detected by the detector device and the detector device decides that a vehicle is passing an expected location on the track if a first one of the at least three receiving antennae and a third one of the at least three receiving antennae receive a larger field intensity than a second one of the at least three receiving antennae in between the first and third receiving antenna.

2. (canceled)

3. The arrangement of claim 1, wherein the emitting antenna is connected to a control device for controlling the operation of the emitting antenna, wherein the electromagnetic field emitted by the emitting antenna is modulated to carry predetermined information and wherein the detector device detects the presence of a vehicle only if the information is received by the receiving antennae at the same time as the maximum or minimum intensity.

4. The arrangement of claim 1, wherein the frequency of the electromagnetic field, which is emitted by the emitting antenna, is in the range of radio frequency radiation, preferably in the range from 10 MHz to 100 GHz.

5. The arrangement of claim 1, wherein the arrangement is adapted to provide a plurality of vehicles, in particular track bound vehicles, with electric energy, wherein:
the arrangement comprises a track-side electric conductor arrangement for producing alternating electromagnetic fields and for thereby transferring electromagnetic energy to the vehicles,
the conductor arrangement comprises a plurality of consecutive segments, wherein each segment extends along a different section of a path of travel of the vehicles,
each of the consecutive segments comprises at least one phase line for carrying a phase of an alternating current for producing the alternating electromagnetic field,
each of the consecutive segments is combined with at least one switching device, for switching on and off the alternating current in the segment,
for each segment at least three receiving antennas according to one of the preceding claims are mounted on the track,
each of the switching devices of each segment is combined with a control device connected to a detector device which detector device is connected to the corresponding switching device of the segment.

6. The arrangement of claim 5, wherein the control device is adapted to control the operation of the switching device or switching devices in such a manner that the alternating current in the corresponding segment of the conductor arrangement is switched on or off if the receiving antenna of the segment receives the maximum or minimum intensity of the electromagnetic field emitted by the emitting antenna on the vehicle.

7. A method of detecting the presence of a vehicle, wherein:
an emitting antenna, which is mounted on the vehicle, is controlled to emit an electromagnetic field in a range of emitting directions, wherein a field intensity of the emitted electromagnetic field is a function of the emitting direction and wherein the function comprises a maximum intensity or a minimum intensity in a predefined emitting direction,
at least three receiving antennae, which are mounted on the track of the vehicle, and which are arranged on the track of the vehicle in close proximity to each other one behind another in the direction of travel of the vehicle, are used to receive a received electromagnetic field, while the vehicle is travelling in a predetermined region of the track, so that part of the emitted electromagnetic field is incident on the receiving antennae,
a detector device, which is connected to each of the receiving antennae, evaluates the field intensity received by each of the receiving antennae, determines information about the received electromagnetic field intensity as a function of the position along the track from the field intensity received by the at least three receiving antennae and is used to detect the presence of the vehicle depending on the field intensity that is received by the receiving antennae,
wherein the detector device detects the presence of the vehicle if a receiving antenna receives the maximum or minimum intensity of the emitted electromagnetic field, and
a) the maximum intensity is detected by the detector device and the detector device decides that a vehicle is passing an expected location on the track if the intensity received by the receiving antenna in a middle position between the other two receiving antennae is larger than for the received intensity of the neighboring two antennae, or
the minimum intensity is detected by the detector device and the detector device decides that a vehicle is passing an expected location on the track if a first one of the at least three receiving antennae and a third one of the at least three receiving antennae receive a larger field intensity than a second one of the at least three receiving antennae in between the first and third receiving antenna.

8. (canceled)

9. The method of claim 7, wherein the emitting antenna is controlled to emit the electromagnetic field in a modulated manner in order to carry predetermined information and wherein the detector device only detects the presence of a vehicle if the information is received by the receiving antennae at the same time as the maximum or minimum intensity.

10. The method of claim 7, wherein the frequency of the electromagnetic field, which is emitted by the emitting antenna, is in the range of radio frequency radiation, preferably in the range from 10 MHz to 100 GHz.

11. The method of claim 7, wherein the method is performed in order to provide a plurality of vehicles, in particular track bound vehicles, with electric energy, wherein:
alternating electromagnetic fields are produced by a track-side electric conductor arrangement, thereby transferring electromagnetic energy to the vehicles,
the conductor arrangement comprises a plurality of consecutive segments, wherein each segment extends along a different section of a path of travel of the vehicles,
each of the consecutive segments comprises at least one phase line for carrying a phase of an alternating current for producing the alternating electromagnetic field,
each of the consecutive segments is combined with at least one switching device, which switches on and off the alternating current in the segment,
for each segment at least one receiving antenna is used on the track in the range of the segment,
each of the switching devices of each segment is controlled depending on the detection result of the detector device.
the operation of the switching device or switching devices is controlled in such a manner that the alternating current in the corresponding segment of the conductor arrangement is switched on or off if the receiving antenna of the segment receives the maximum or minimum intensity of the electromagnetic field emitted by the emitting antenna on the vehicle.
